(19) United States
(12) Patent Application Publication
(10) Pub. No.: US 2025/0269594 A1
(43) Pub. Date: Aug. 28, 2025

(54) DEVICES AND METHODS TO FABRICATE CONTINUOUS STRUCTURES USING ADDITIVE MANUFACTURING

(71) Applicant: The Government of the United States of America, as represented by the Secretary of the Navy, Arlington, VA (US)

(72) Inventors: Daniel L. Rhonehouse, Huntingtown, MD (US); Woohong Kim, Lorton, VA (US); Jasbinder S. Sanghera, Ashburn, VA (US); Jesse A. Frantz, Washington, DC (US); Geoffrey D. Chin, Oakton, VA (US); Robert R. Nicol, JR., Washington, DC (US)

(73) Assignee: The Government of the United States of America, as represented by the Secretary of the Navy, Arlington, VA (US)

(21) Appl. No.: 19/049,436

(22) Filed: Feb. 10, 2025

Related U.S. Application Data
(60) Provisional application No. 63/556,532, filed on Feb. 22, 2024.

(51) Int. Cl. B29C 64/232; B29C 64/112; B29C 64/118; B29C 64/245; B33Y 10/00; B33Y 30/00

(52) U.S. Cl. CPC B29C 64/232; B29C 64/112; B29C 64/118; B29C 64/245; B33Y 10/00; B33Y 30/00

(57) ABSTRACT

According to some embodiments of the present disclosure, an additive manufacturing device may include a deposition source, a traction driver, and a controller coupled with the deposition source and the traction driver. The deposition source is configured to deposit material for a three-dimensional structure on a deposition surface of a pedestal, wherein the pedestal has an elongate shape defining an axis and providing the deposition surface at an end of the pedestal. The traction driver is configured to engage with the pedestal and the three-dimensional structure to move the pedestal and the three-dimensional structure in a direction of the axis of the pedestal. The controller is configured to control the deposition source to deposit the three-dimensional structure on the deposition surface of the pedestal while controlling the traction driver to move the pedestal in the direction of the axis away from the deposition source. Related methods are also discussed.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/556,532 filed on Feb. 22, 2024. The disclosures of Provisional Application No. 63/556,532 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #211486-US2.

### TECHNICAL FIELD

The present disclosure relates to additive manufacturing and more particularly to devices and methods providing additive manufacturing.

### BACKGROUND OF THE INVENTION

Polymer hollow tubular structures have traditionally been fabricated using extrusion. While extrusion techniques are mature and ubiquitous, extrusion may have limitations. Two such limitations may include restricted flow through very narrow die channels due to shear flow resistance and collapse of structures due to surface tension. Thus, extrusion techniques may not be particularly suitable for complex geometries with very small features and/or designs without robust multi-dimensional support structures to counteract surface tension.

Additive manufacturing techniques, such as fused deposition modelling (FDM) or stereolithography (SLA) 3D printing, may allow complex shapes to be made with a high degree of accuracy. Commercial 3D printers may, however, be limited with respect to build volume, e.g., usually less than one meter in any coordinate direction (see, Reference [1]).

As shown in FIG. 6A, a commercial belt 3D printer may utilize a single ‘conveyor-style’ belt bed 101 oriented with a slight decline in the x-y plane to create an infinite z-axis. By printing a layer in the x-y plane and moving the part in a slight incline in the z direction, the part is produced in both horizontal as well as vertical planes. Although this setup may work well for mass production of single discontinuous solid models (e.g., chess pieces as shown in FIG. 6A), it may not be suitable for long parts with structures that lack multi-dimensional support (e.g., very thin structures and/or structures including hollow cavities) because the lack of support may allow printed parts to slump under gravitational forces (as shown in FIG. 6B).

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, an additive manufacturing device includes a deposition source, a taction driver, and a controller coupled with the deposition source and the traction driver. The deposition source is configured to deposit material for a three-dimensional structure on a deposition surface of a pedestal, wherein the pedestal has an elongate shape defining an axis and providing the deposition surface at an end of the pedestal. The traction driver is configured to engage with the pedestal and the three-dimensional structure to move the pedestal and the three-dimensional structure in a direction of the axis of the pedestal. The controller is configured to control the deposition source to deposit the three-dimensional structure on the deposition surface of the pedestal while controlling the traction driver to move the pedestal in the direction of the axis away from the deposition source.

According to some other embodiments of inventive concepts, a method provides additive manufacturing on a pedestal having an elongate shape defining an axis and providing a deposition surface. The method includes depositing a three-dimensional structure from a deposition source on the deposition surface of the pedestal while moving the pedestal in the direction of the axis away from the deposition source.

### BRIEF DESCRIPTION OF DRAWINGS

Examples of embodiments of inventive concepts may be more clearly understood from the following detailed description taken in conjunction with the accompanying drawings in which:

FIG. 1 is a diagram illustrating an apparatus including a printhead, print layer, two guide plates, a twin belt tractor, print pedestal, and printed structure where the print pedestal and printed structure are co-aligned and oriented in the vertical plane according to some embodiments of inventive concepts, with the x-axis being oriented horizontally across the page, the z-axis being oriented vertically up and down the page, and the y-axis being oriented into and out of the page;

FIG. 2 is a diagram illustrating the twin belt tractor of FIG. 1 oriented in the vertical plane, with z-axis assigned to the same plane according to some embodiments of inventive concepts, where the x-axis is oriented horizontally across the page, the z-axis is oriented vertically up and down the page, and the y-axis is oriented into and out of the page;

FIGS. 3A and 3B are plan views illustrating respective upper and lower guide plates of FIG. 2 according to some embodiments of inventive concepts;

FIGS. 3C and 3D are cross-sectional views illustrating respective slots of the guide plates of FIGS. 3A and 3B according to some embodiments of inventive concepts;

FIG. 4 is a view of the assembled apparatus of FIG. 2 according to some embodiments of inventive concepts, where the x-axis is oriented horizontally across the page, the z-axis is oriented vertically up and down the page, and the y-axis is oriented into and out of the page;

FIGS. 5A and 5B illustrate an example of a structure fabricated using the apparatus of FIGS. 1, 2, 3A-D, and 4 according to some embodiments of inventive concepts;

FIG. 6A is a photograph illustrating a commercial belt 3D printer;

FIG. 6B illustrates an example of a structure fabricated using a commercial belt 3D printer of FIG. 6A, where the z-axis is oriented in the horizontal plane resulting in slumped features;

FIG. 7 is a block diagram illustrating the controller of FIG. 1 according to some embodiments of inventive concepts; and

FIGS. 8A and 8B are respective side and top views of a printed structure formed using the apparatus of FIGS. 1, 2, 3A-D, and 4 according to some embodiments of inventive concepts.

### DETAILED DESCRIPTION

Inventive concepts will be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. In the drawings, like reference numerals refer to like elements throughout, and the sizes of elements may be exaggerated for clarity and conveniences of explanation. Moreover, it will be understood that the disclosed aspects, features, and/or embodiments are merely examples, and that one skilled in the art may use other aspects, features, and/or embodiments or make functional and/or structural modifications without departing from the scope of the present disclosure.

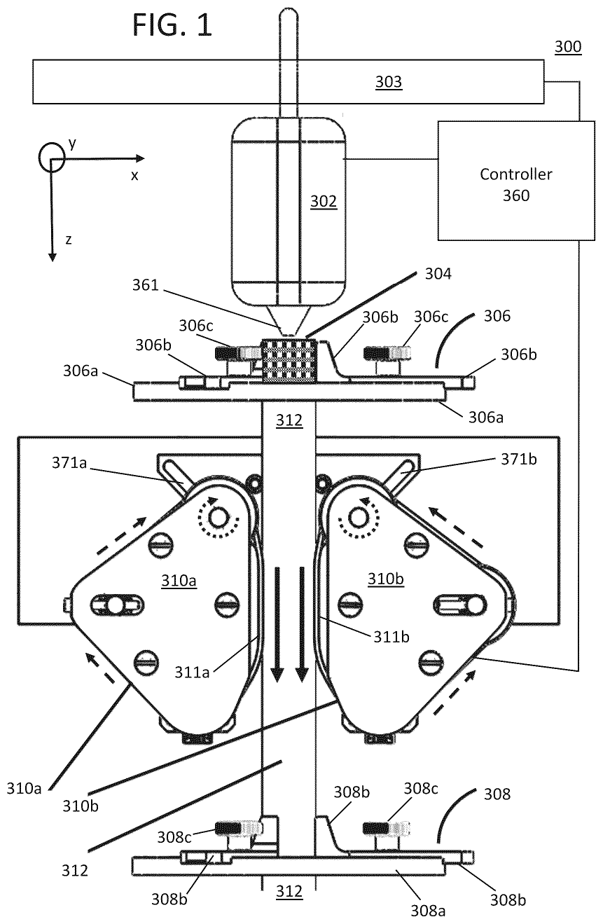

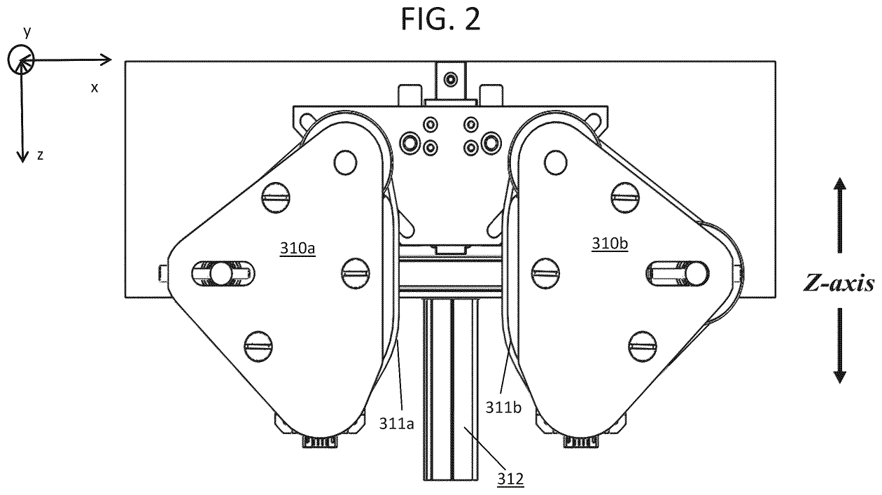

Some embodiments of the present disclosure provide devices and methods used to fabricate continuous structures by providing a 3-Dimensional (3D) printer system with a twin belt-driven tractor to form a single printed/manufactured part/structure. Moreover, each of the belt-driven tractors may be oriented in alignment with a vertical z-axis of a pedestal as shown in FIGS. 1 and 2. According to some embodiments of inventive concepts, devices and methods disclosed herein may also be adaptable to different materials, lengths, and/or sizes, and/or may allow precise control from design to actual printed/manufactured part/structure.

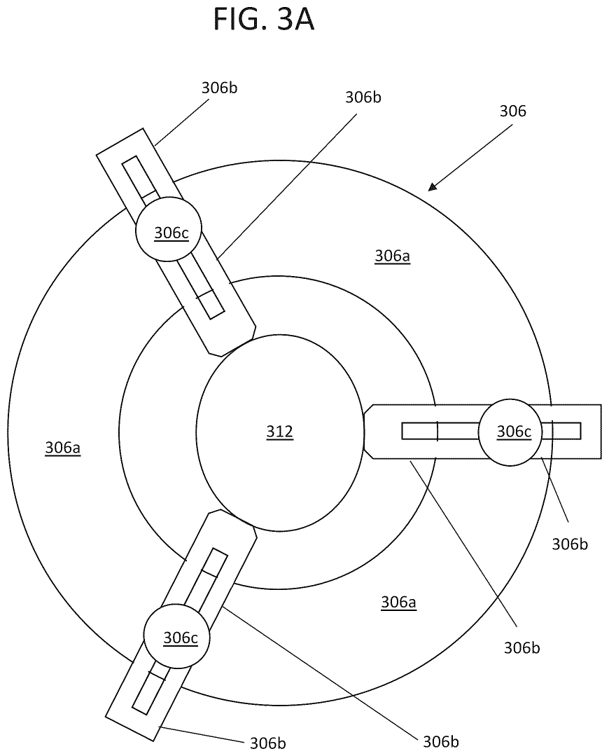

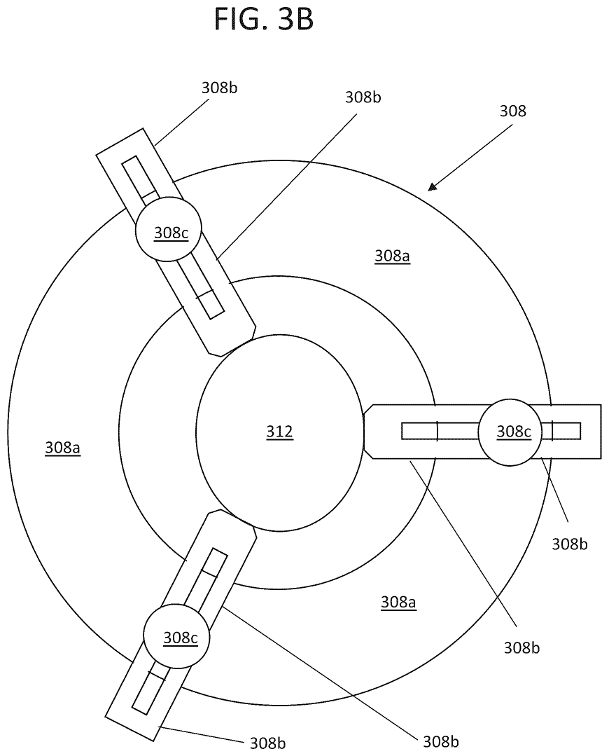

In some embodiments of the present disclosure, a Cartesian Fused Deposition Modeling (FDM)-style 3D printer is used due to its many advantageous features, including high precision, fast print times, and stability. Meanwhile, belt-driven tractors may be economical and simple to use, and may provide smooth operation and the ability to print continuously in a user-defined z coordinate/axis. Devices and methods to fabricate continuous structures using the 3D printing apparatus 300 of FIGS. 1, 2, 3A-D, 4, and 5A-B are described in further detail below.

The 3D printing apparatus 300 of FIGS. 1, 2, 3A-D, 4, and 5A-B may include the elements discussed below.

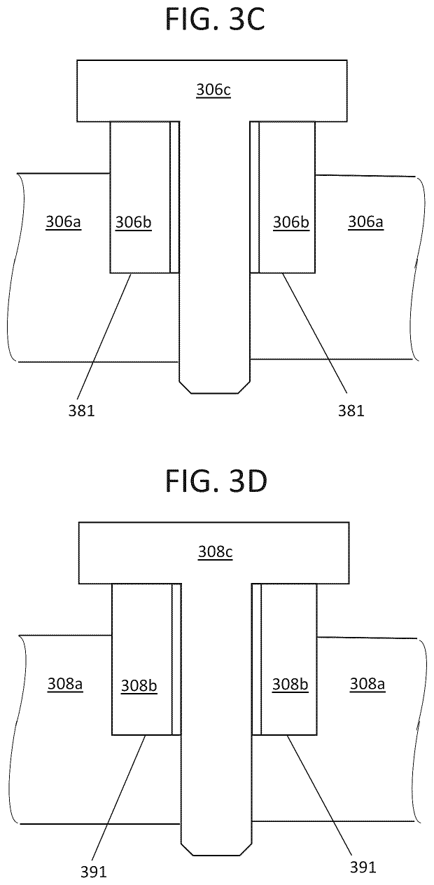

The 3D printer (including printhead 302 and gantry 303) is located in an upper box frame, with the printhead 302 mounted on gantry 303 and fixed in the x-y plane as shown in FIGS. 1 and 4. Accordingly, the printhead 302 is moveable in 2 dimensions in the x-y plane while dispensing print material from dispensing nozzle 361.

A custom machined rod with an embedded heater and thermocouple may serve as a printing pedestal 312 as shown in FIGS. 1, 2, and 4.

The pedestal 312 is held in place using a pair of belt tractors 310a and 310b as shown in FIGS. 1, 2, and 4) oriented in parallel with the z-axis in a vertical plane. Each belt tractor 310a and 310b includes a respective belt 311a and 311b (also referred to as tractor or traction belt) configured to engage with the pedestal 312 and then with the manufactured structure 304 (e.g., a printed structure or an extruded structure) as a length of the manufactured structure 304 increases. Accordingly, the pedestal 312 is moveable in parallel with the z-axis in a vertical direction under control of belt tractors 310a and 310b.

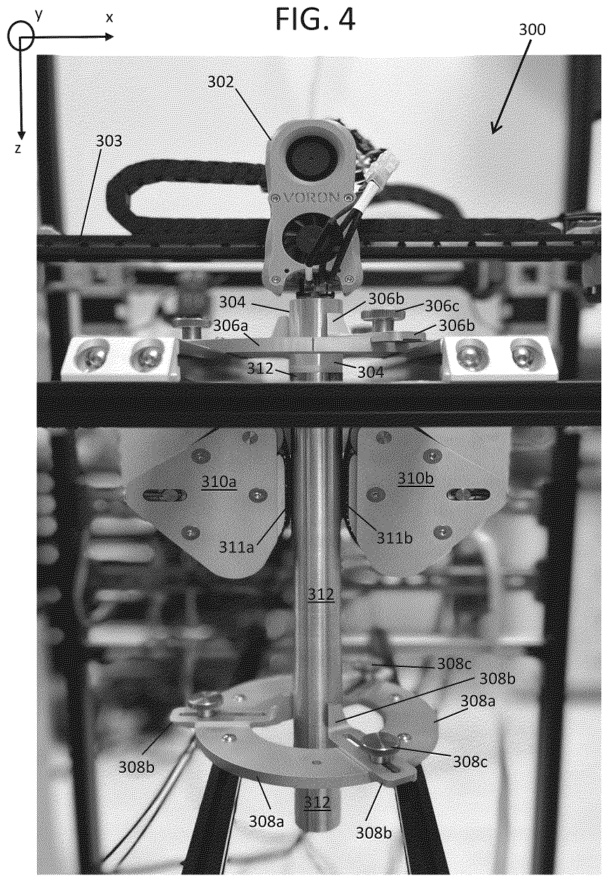

Two guide plates 306 and 308 placed above and below the belt tractors 310a and 310b may assist in centering and aligning pedestal 312 and subsequently manufactured structure 304 along the z-axis. In the example of FIGS. 1, 3A, and 3C, 4, and 5A-B upper guide plate 306 may include a collar 306a and a plurality of arms 306b configured to guide the pedestal 312 in the z direction, while restricting/limiting motion of the pedestal 312 in the x and y directions. Similarly, as shown in FIGS. 1, 3B, 3D, and 4 lower guide plate 308 may include a collar 308a and a plurality of arms 308b configured to guide the pedestal 312 in the z direction, while restricting/limiting motion of the pedestal 312 in the x and y directions. The arms 306b/308b may be moveable in slots 381/391 of the respective collars 306a/308a to accommodate pedestals of different diameters/widths with thumbscrews 306c/308c used to lock respective arms 306b/308b into position after adjustment. Similarly, spacing of belt tractors 310a/b may be adjusted along tracks 371a and 371b to accommodate pedestals 312 and manufactured structures 304 of different widths.

The counter-rotating belts 311a and 311b (with the counter-rotating motion shown as dotted rotational lines in FIG. 1) are forced onto opposing sides of the pedestal/fiber by pneumatic pressure or other apparatus (e.g., applied by connection of belt tractors 310a and 310b via respective tracks 371a and 371b). The belts 311a/b grip the pedestal 312 and/or the manufactured structure 304 (e.g., a fiber), and the counter-rotating belts 311a/b (with belt movement depicted as dashed lines shown in FIG. 1) to cause the pedestal 312 and/or manufactured structure 304 to traverse in the z direction (downward vertical movement depicted as double solid arrows shown in FIG. 1) either in a continuous fashion for continuous printing or a stepwise fashion for “layer-by-layer” printing. Both belt tractors 310a-b and guide plates 306 and 308 may be housed within a second box frame, which is open at the bottom to allow the manufactured structure 304 to pass through, thus creating a potentially infinite z-axis to manufacture the manufactured structure 304 having potentially infinite length. Stated in other words, a length of the resulting manufactured structure 304 is not limited by a limit of vertical motion of the print head 302 or by a limit of motion of pedestal 312. The upper and lower box frames are co-aligned and attached as one physical unit. By orienting the pedestal 312 and the manufactured structure 304 in the vertical direction with the manufactured structure 304 supported by the pedestal 312 and/or previously formed layers/portions of the manufactured structure 304, effects of slumping across a width of the manufactured structure 304 under gravitational forces can be reduced/eliminated.

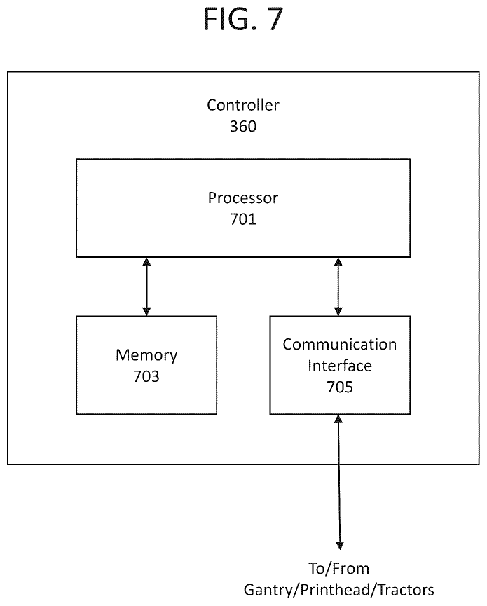

According to some embodiments of inventive concepts illustrated in FIG. 7, controller 360 includes processor 701 (also referred to as processing circuitry), memory 703 (also referred to as memory circuitry) coupled with processor 701, and communication interface 795 coupled with processor 701. Communication interface 705 is also coupled with gantry 303, printhead 302, and belt tractors 310a/b to provide control communications between processor 701 and each of gantry 303, printhead 302, and belt tractors 310a/b. Processor 701 is coupled with memory 703, and memory 703 may include computer readable program code that when executed by processor 701 causes processor 701 to perform operations according to embodiments disclosed herein. Accordingly, processor 701 may execute computer readable program code of memory 703 to perform operations as disclosed herein. According to other embodiments, processor 701 may be defined to include memory so that separate memory is not required.

Controller 360 is thus configured to control gantry 303, printhead 302, and belt tractors 310a and 310b to form structure 304 as disclosed herein. For example, controller 360 may control positioning of printhead 302 in the x-y (horizontal) plane and positioning of the pedestal and/or manufactured structure 304 in the z-axis (vertical) direction while controlling dispensing of print material from nozzle 361 to form structure 304. In such embodiments, controller 360 controls belt tractors 310a/b to position pedestal 312 in a first position, and controller 360 controls printhead 302 and gantry 303 to form a first layer of structure 304 on pedestal 312 by dispensing print material through nozzle 361 while moving printhead 302 in the x-y plane while maintaining pedestal 312 and structure 304 in the first position. After forming the first layer, controller 360 controls belt tractors 310a/b to move pedestal 312 and structure 304 down (in the z-axis direction) to a second position, and controller 360 controls printhead 302 and gantry 303 to form a second layer of structure 304 on pedestal 312 by dispensing print material through nozzle 361 while moving printhead 302 in the x-y plane while maintaining pedestal 312 and structure 304 in the second position. These operations can be repeated to form any number of layers (on preceding layers) with pedestal 312 and/or structure 304 being moved down for each layer formed.

Accordingly, a length of the resulting structure 304 is not limited by dimensions of the 3D printing apparatus 300 used to print structure 304. For example, outer cross-sectional dimensions of pedestal 312 in a horizontal x-y plane may be provided to match outer cross-sectional dimensions of the structure 304 in a horizontal x-y plane so that belt tractors 310a/b can grip pedestal 312 and then structure 304 as a length of structure 304 increases. Accordingly, structure 304 may be formed to include any number of layers, and once pedestal 312 moves down beyond belt tractors 310a/b while forming structure 304, belt tractors 310a/b may directly engage with structure 304 to control a position of the top surface of structure 304 with respect to printhead 302 to print each layer of structure 304.

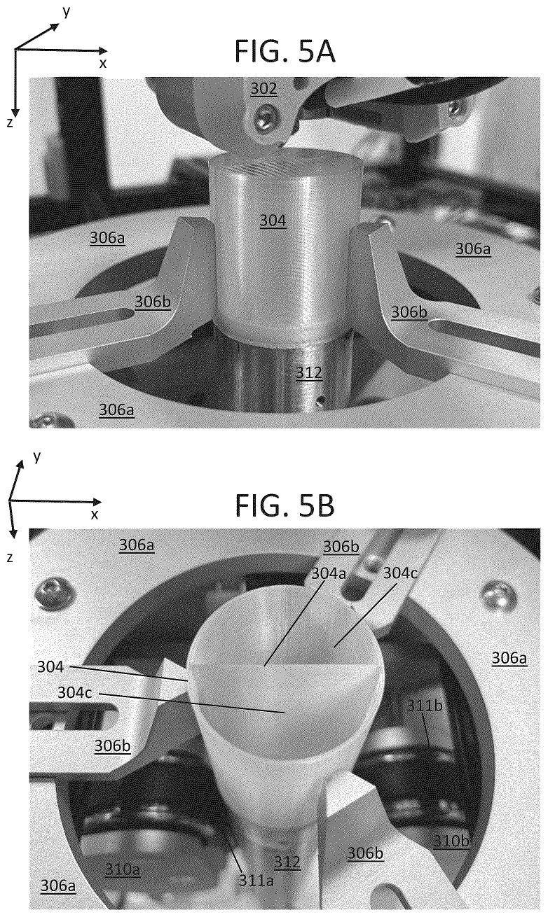

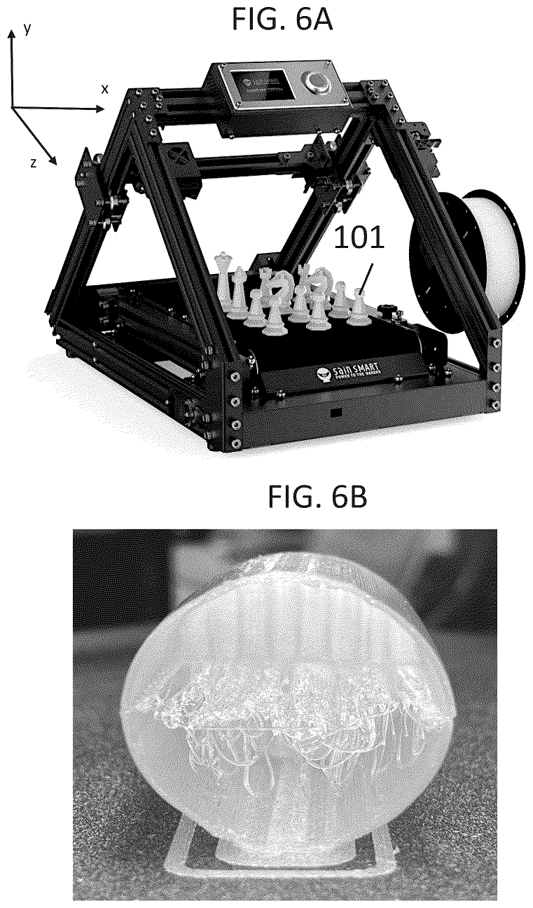

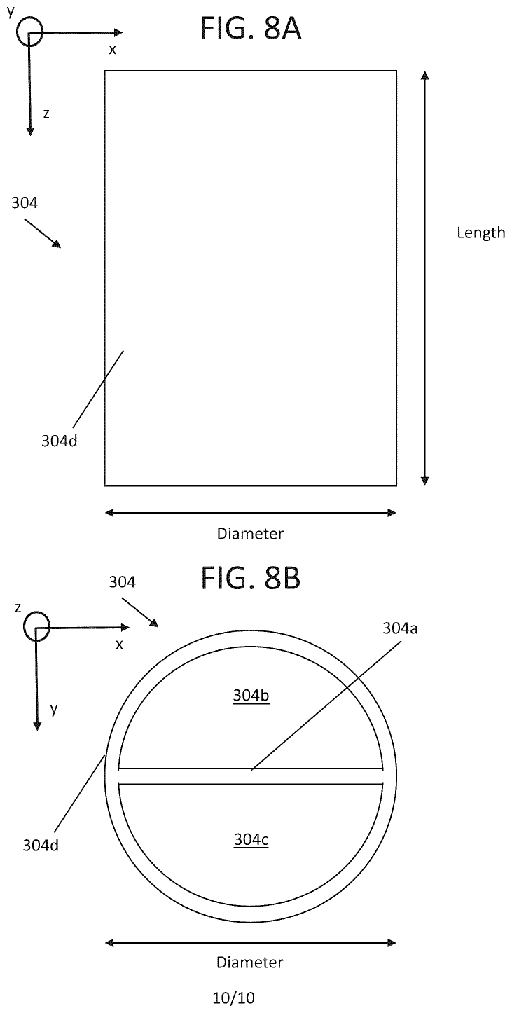

In the example of FIGS. 1, 2, 3A-D, 4, 5a, and 5b, a continuous manufactured structure 304 shown in FIGS. 8A and 8B may be fabricated using the apparatus described above with respect to FIGS. 1, 2, 3A-D, and 4. The manufactured structure 304 of FIGS. 1, 4, 5A-B, and 8A-B may have outer sidewall 304d defining a circular outer cross-sectional dimension with a diameter of 36 millimeters and with a bisecting line 304a that is 0.40 millimeters in width and that separates cavities 304b and 304c (also referred to as hollow portions or voids) in the manufactured structure 304. Pedestal 312 also has a circular outer cross-sectional dimension with a diameter of 36 mm to match that of structure 304. The total length (also referred to as height, along the z-axis) of the manufactured structure 304 of FIGS. 1, 4, 5A, 5B, 8A, and 8B is approximately 55 millimeters, but the length/height may be increased. The example of FIGS. 1, 2, 3A-D, 4, 5A-B, and 8A-B illustrates that printing along the z-axis in a vertical plane may provide multi-dimensional support resulting in better print quality versus printing the same part across a horizontal plane which may result in deformed structures due to viscous flow under gravitational forces (as shown in FIG. 6B).

Advantages and new features according to some embodiments of inventive concepts are discussed below.

Some embodiments of inventive concepts may provide methods to fabricate continuous structures using a novel apparatus including a top region housing an additive manufacturing device (including printhead 302 and gantry 303) and a lower region housing top and bottom guide plates 306 and 308 as well as a way to convey (e.g., belt tractors 310a and 310b) the printing pedestal 312 and manufactured structure 304 oriented along a vertical axis (z-axis).

Some embodiments of inventive concepts may provide that both top and bottom regions of the 3D printing apparatus are co-aligned and attached as one physical unit.

Some embodiments of inventive concepts may incorporate an additive manufacturing device, which is a 3D printer (including printhead 304 and gantry 303).

Some embodiments of inventive concepts may include a twin belt tractor (e.g., including belt tractors 310a and 310b) as a way to convey the printing pedestal 312 and manufactured structure 304 downward in the direction of the z-axis.

Some embodiments of inventive concepts may include a printing pedestal 312 that provides a platform on which initial printing/manufacturing takes place, and which moves downward to allow successive layers to be printed/manufactured, thus creating a substantially “infinite” z-axis.

Therefore, some embodiments of inventive concepts may provide a capability to print structures with reduced/minimal multi-dimensional support in a continuous fashion. Additional embodiments are discussed below.

According to some embodiments of inventive concepts, the additive manufacturing apparatus may include an extruder (replacing printhead 302). In such embodiments, the extruder may extrude the continuous structure (e.g., a continuous extruded structure as opposed to a continuous printed structure) vertically down onto an upper surface of pedestal 312 (e.g., an extruding pedestal 312 as opposed to a printing pedestal), and belt tractors 310a and 310b may move pedestal 312 and then structure 304 down as a length of structure 304 increases.

According to some embodiments of inventive concepts, the additive manufacturing device may include a multi-jet fusion (MJF) printer.

According to some embodiments of inventive concepts, the additive manufacturing device (including printhead 302 and gantry 303) may include a stereolithography (SLA) Printer.

According to some embodiments of inventive concepts, the additive manufacturing device (including printhead 302 and gantry 303) may include a Polyjet printer.

According to some embodiments of inventive concepts, the belt tractors may be replaced with two or more opposing wheels (also referred to as traction wheels).

According to some embodiments of inventive concepts, a plurality (two or more) of tractor belts, tractor wheels, and/or other drive apparatus may be used to control a descent of the pedestal 312 and structure 304 in the vertical direction as a length of structure 304 increases due to additive manufacturing (e.g., via 3D printing, extrusion, etc.). For example, a plurality of tractor belts or tractor wheels may be arranged symmetrically around pedestal 312 and/or structure 304. With 2 tractor belts (as shown in FIGS. 1, 2, and 4) or 2 tractor wheels, for example, the tractor belts or wheels may be arranged on opposite sides of the pedestal 312 and/or structure 304 (i.e., separated by 180 degrees). With 3 tractor belts or 3 tractor wheels, the tractor belts or wheels may be separated by 120 degrees around the pedestal 312 and/or structure 304.

According to some embodiments of inventive concepts, one or more tractor belts/wheels may be actively driven to control the descent of pedestal 312 and/or structure 304 and one or more other belts/wheels may passively rotate to maintain an alignment of the pedestal 312 and/or structure 304 and/or to maintain a pressure between pedestal/structure 312/304 and an actively driven tractor belt/wheel.

The disclosures of each of the following references are hereby incorporated herein in it their entireties by reference.
Reference [1.] SULTANA, J., et al., “Exploring Low Loss and Single Mode in Antiresonant Tube Lattice Terahertz Fibers,” IEEE Access (US), Vol. 8, pages 113309-113117, June 2020.
Reference [2.] VAN PUTTEN, L. D., et al., “3D-printed polymer antiresonant waveguides for short-reach terahertz applications,” Appl. Opt. (US), Vol. 57, No. 14, pages 3953-3958, 10 May 2018.
Reference [3.] CRUZ, A. L. S., et al., “3D printed hollow core fiber with negative curvature for terahertz applications,” J. Microwaves, Optoelectron. Electromagn. Appl. (BR), Vol. 14, pp. SI-45 to SI-53, July 2015.

Example Embodiments are provided below. Reference numbers (referencing elements of the figures) are provided in these examples by way of example without limiting the Example Embodiments to the particular elements/operations from the figures.

Embodiment 1. An additive manufacturing device comprising: a deposition source configured to deposit material for a three dimensional structure (304) on a deposition surface of a pedestal (312), wherein the pedestal (312) has an elongate shape defining an axis and providing the deposition surface at an end of the pedestal; a traction driver (310a, 310b) configured to engage with the pedestal (312) and the three dimensional structure (304) to move the pedestal and the three dimensional structure in a direction of the axis of the pedestal; and a controller (360) coupled with the deposition source and the traction driver, wherein the controller is configured to, control the deposition source to deposit the three dimensional structure (304) on the deposition surface of the pedestal while controlling the traction driver to move the pedestal in the direction of the axis away from the deposition source.

Embodiment 2. The additive manufacturing device of Embodiment 1, wherein the material comprises a three-dimensional print material, and wherein the deposition source comprises a printhead (302) configured to selectively dispense the three-dimensional print material in a plane that is orthogonal with respect to the direction of the axis responsive to control from the controller.

Embodiment 3. The additive manufacturing device of Embodiment 2, wherein the deposition source comprises a gantry (303) configured to move the printhead (302) in a plane that is orthogonal with respect to the direction of the axis responsive to control from the controller

Embodiment 4. The additive manufacturing device of any of Embodiments 1-3, wherein the traction driver comprises a rotational engagement device configured to engage with the pedestal and the three-dimensional structure such that rotation of the rotational engagement device moves the pedestal away from the deposition source.

Embodiment 5. The additive manufacturing device of Embodiment 4, wherein the rotational engagement device comprises at least one of a traction belt and/or a traction wheel configured to engage with the pedestal (312) and the three-dimensional structure (304).

Embodiment 6. The additive manufacturing device of any of Embodiments 4-5, wherein the traction driver comprises a plurality of rotational engagement devices distributed around the pedestal and/or the three-dimensional structure.

Embodiment 7. The additive manufacturing device of any of Embodiments 1-6, where pedestal (312) has an outer cross sectional shape in a plane that is orthogonal with respect to the direction of the axis, wherein the three dimensional structure (304) has an outer cross sectional shape in a plane that is orthogonal with respect to the direction of the axis, and wherein the outer cross sectional shape of the three dimensional structure (304) is the same as the outer cross sectional shape of the pedestal (312).

Embodiment 8. The additive manufacturing device of Embodiment 7, wherein the outer cross-sectional shapes of the pedestal (312) and the three-dimensional structure (304) are one of a circle, an oval, a square, a rectangle, a triangle, a pentagon, or a hexagon.

Embodiment 9. The additive manufacturing device of any of Embodiments 1-8, wherein the controller is configured to control the deposition source to deposing the three dimensional structure by, controlling the deposition source to deposit a first layer of the three dimensional structure on the deposition surface with the pedestal in a first position such that the deposition surface is at a first distance from the deposition source, after depositing the first layer of the three dimensional structure, controlling the traction driver to move the pedestal in the direction of the axis from the first position to a second position such that the deposition surface is at a second distance from the deposition source, with the second distance being greater than the first distance, and after moving the pedestal to the second position, controlling the deposition source to deposit a second layer of the three dimensional structure on the first layer.

Embodiment 10. The additive manufacturing device of any of Embodiments 1-8, wherein the controller is configured to control the deposition source to deposit the three-dimensional structure by, controlling the deposition source to deposit the three-dimensional structure from the deposition source on the deposition surface while controlling the traction driver to continuously move the pedestal in the direction of the axis away from the deposition source.

Embodiment 11. A method providing additive manufacturing on a pedestal (312) having an elongate shape defining an axis and providing a deposition surface, the method comprising: depositing a three-dimensional structure (304) from a deposition source on the deposition surface of the pedestal (312) while moving the pedestal (312) in the direction of the axis away from the deposition source.

Embodiment 12. The method of Embodiment 11, where pedestal (312) has an outer cross sectional shape in a plane that is orthogonal with respect to the direction of the axis, wherein the three dimensional structure (304) has an outer cross sectional shape in a plane that is orthogonal with respect to the direction of the axis, and wherein the outer cross sectional shape of the three dimensional structure (304) is the same as the outer cross sectional shape of the pedestal (312).

Embodiment 13. The method of Embodiment 12, wherein the outer cross-sectional shapes of the pedestal (312) and the three-dimensional structure (312) are one of a circle, an oval, a square, a rectangle, a triangle, a pentagon, or a hexagon.

Embodiment 14. The method of any of Embodiments 11-13, wherein depositing the three-dimensional structure while moving the pedestal in the direction of the axis comprises, depositing a first layer of the three dimensional structure on the deposition surface with the pedestal in a first position such that the deposition surface is at a first distance from the deposition source, after depositing the first layer of the three dimensional structure, moving the pedestal in the direction of the axis from the first position to a second position such that the deposition surface is at a second distance from the deposition source, with the second distance being greater than the first distance, and after moving the pedestal to the second position, depositing a second layer of the three dimensional structure on the first layer.

Embodiment 15. The method of any of Embodiments 11-13, wherein depositing the three-dimensional structure while moving the pedestal in the direction of the axis comprises, depositing the three-dimensional structure from the deposition source on the deposition surface while continuously moving the pedestal in the direction of the axis away from the deposition source.

Some embodiments of inventive concepts may thus provide methods and systems of making continuous length (e.g., essentially “infinite” length) structures such as fiber optics via 3D printing from various materials including polymers. Such methods and systems may thus be used to provide long-length waveguides for millimeter-wave imaging systems used for long-range target detection through optical obscurants such as fog, which occurs frequently in marine environments. Such methods and systems may also reduce the need for bulky and/or expensive extruder systems and/or the need for new extrusion dies for each design iteration.

According to some embodiments of inventive concepts, printed structure 304 may be printed layer by layer (in the x-y plane as discussed above), and as each layer is printed, printed structure 304 may travel downward (in a direction of the z-axis as discussed above). As layers are added to printed structure 304, previously formed layers (i.e., lower portions of printed structure 304) exit through guide plate 306, through traction drivers 310a and 310b, and then through guide plate 308.

System 300 disclosed herein may have a height (in the direction of the z-axis as illustrated) from guide plate 308 to gantry 303 of no more than about 24 inches. For printed structures formed from flexible materials (e.g., from flexible polymers), the printed structure 304 can be spooled continuously upon exiting from guide plate 308 so that there is effectively no limit to the length to which the printed structure can be formed. For printed structures formed from stiff materials (e.g., stiff polymers), a length of the printed structure may only be limited by a vertical height of the building in which the system is housed. Accordingly, a length of the continuously printed structure is not limited by the vertical height of the printing system. As proof of concept, a system according to embodiments of the present disclosure has been used to form a continuous printed structure having a length greater than 4 meters. Such systems may be used to form custom printed functional parts such as connectors, elbows, combiners, arrays, and/or complex 3D non-extrudable structures.

Methods and systems according to some embodiments of inventive concepts may thus be used to provide printed structures for applications that use advanced sensors and/or communication systems with higher frequencies, broader bandwidths, and/or lower latencies. Such methods and systems, for example, may be used to form: fiber-optic printed structures for coherent long-haul communications having lengths greater than about 80 km; fiber-optic printed structures for multi-wavelength metro core communications having lengths in the range of about 100 km to about 800 km; and/or fiber-optic printed structures for SAN, LAN, and/or Access data communications up to 10 meters, up to 50 meters, and/or up to 100 km.

3D printing of continuous lengths of polymers according to some embodiments of inventive concepts may enable the production of a wide variety of fiber optics to be produced. These fiber optics can be made from a wide variety of polymers. Due to the vast number of available polymers, each with distinct thermal, optical, and mechanical properties, fiber properties can be tailored over a very wide range. Furthermore, the speed at which fibers can be produced and tested using methods and systems disclosed herein may allow researchers to quickly test new designs. Moreover, methods and systems disclosed herein may allow fibers to be produced for use at wavelengths previously unused due to material and/or manufacturing issues. In addition, low loss flexible waveguides may be provided for spectral regions for which such waveguides have been previously unavailable. Additional definitions are provided below.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on”, “connected” to/with, or “coupled” to/with another element, it can be directly on, connected to/with, or coupled to/with the other element, or intervening elements may be present. In contrast, when an element is referred to as being “directly on”, “directly connected” to/with, or “directly coupled” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated as a rectangle or other polygon may, typically, have rounded or curved features and/or a gradient of refractive index at its edges rather than a binary change from one refractive index to another refractive index. Thus, the regions illustrated in the figures are schematic in nature and their shapes are not intended to illustrate the actual shape of a region of a device and are not intended to limit the scope of the present inventive concepts.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

Unless otherwise defined, all terms (including technical and scientific terms) used herein have the same meaning as commonly understood by one of ordinary skill in the art to which inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the scope of the following claims.

1. An additive manufacturing device comprising:
a deposition source configured to deposit material for a three-dimensional structure on a deposition surface of a pedestal, wherein the pedestal has an elongate shape defining an axis and providing the deposition surface at an end of the pedestal;
a traction driver configured to engage with the pedestal and the three-dimensional structure to move the pedestal and the three-dimensional structure in a direction of the axis of the pedestal; and
a controller coupled with the deposition source and the traction driver, wherein the controller is configured to,
control the deposition source to deposit the three-dimensional structure on the deposition surface of the pedestal while controlling the traction driver to move the pedestal in the direction of the axis away from the deposition source.

2. The additive manufacturing device of claim 1, wherein the material comprises a three-dimensional print material, and wherein the deposition source comprises a printhead configured to selectively dispense the three-dimensional print material in a plane that is orthogonal with respect to the direction of the axis responsive to control from the controller.

3. The additive manufacturing device of claim 2, wherein the deposition source comprises a gantry configured to move the printhead in a plane that is orthogonal with respect to the direction of the axis responsive to control from the controller.

4. The additive manufacturing device of claim 1, wherein the traction driver comprises a rotational engagement device configured to engage with the pedestal and the three-dimensional structure such that rotation of the rotational engagement device moves the pedestal away from the deposition source.

5. The additive manufacturing device of claim 4, wherein the rotational engagement device comprises at least one of a traction belt and/or a traction wheel configured to engage with the pedestal and the three-dimensional structure.

6. The additive manufacturing device of claim 4, wherein the traction driver comprises a plurality of rotational engagement devices distributed around the pedestal and/or the three-dimensional structure.

7. The additive manufacturing device of claim 1, where pedestal has an outer cross sectional shape in a plane that is orthogonal with respect to the direction of the axis, wherein the three dimensional structure has an outer cross sectional shape in a plane that is orthogonal with respect to the direction of the axis, and wherein the outer cross sectional shape of the three dimensional structure is the same as the outer cross sectional shape of the pedestal.

8. The additive manufacturing device of claim 7, wherein the outer cross-sectional shapes of the pedestal and the three-dimensional structure are one of a circle, an oval, a square, a rectangle, a triangle, a pentagon, or a hexagon.

9. The additive manufacturing device of claim 1, wherein the controller is configured to control the deposition source to deposing the three-dimensional structure by,
controlling the deposition source to deposit a first layer of the three-dimensional structure on the deposition surface with the pedestal in a first position such that the deposition surface is at a first distance from the deposition source,
after depositing the first layer of the three-dimensional structure, controlling the traction driver to move the pedestal in the direction of the axis from the first position to a second position such that the deposition surface is at a second distance from the deposition source, with the second distance being greater than the first distance, and
after moving the pedestal to the second position, controlling the deposition source to deposit a second layer of the three-dimensional structure on the first layer.

10. The additive manufacturing device of claim 1, wherein the controller is configured to control the deposition source to deposit the three-dimensional structure by,
controlling the deposition source to deposit the three-dimensional structure from the deposition source on the deposition surface while controlling the traction driver to continuously move the pedestal in the direction of the axis away from the deposition source.

11. A method providing additive manufacturing on a pedestal having an elongate shape defining an axis and providing a deposition surface, the method comprising:
depositing a three-dimensional structure from a deposition source on the deposition surface of the pedestal while moving the pedestal in the direction of the axis away from the deposition source.

12. The method of claim 11, where pedestal has an outer cross sectional shape in a plane that is orthogonal with respect to the direction of the axis, wherein the three dimensional structure has an outer cross sectional shape in a plane that is orthogonal with respect to the direction of the axis, and wherein the outer cross sectional shape of the three dimensional structure is the same as the outer cross sectional shape of the pedestal.

13. The method of claim 12, wherein the outer cross-sectional shapes of the pedestal and the three-dimensional structure are one of a circle, an oval, a square, a rectangle, a triangle, a pentagon, or a hexagon.

14. The method of claim 11, wherein depositing the three-dimensional structure while moving the pedestal in the direction of the axis comprises,
depositing a first layer of the three-dimensional structure on the deposition surface with the pedestal in a first position such that the deposition surface is at a first distance from the deposition source,
after depositing the first layer of the three-dimensional structure, moving the pedestal in the direction of the axis from the first position to a second position such that the deposition surface is at a second distance from the deposition source, with the second distance being greater than the first distance, and
after moving the pedestal to the second position, depositing a second layer of the three-dimensional structure on the first layer.

15. The method of claim 11, wherein depositing the three-dimensional structure while moving the pedestal in the direction of the axis comprises,
depositing the three-dimensional structure from the deposition source on the deposition surface while continuously moving the pedestal in the direction of the axis away from the deposition source.
